(19) United States
(12) Patent Application Publication
(10) Pub. No.: US 2009/0140878 A1
(43) Pub. Date: Jun. 4, 2009

(54) SOUND CUSTOMIZATION FOR OPERATING ACTIONS OF AUTOMOBILES

(76) Inventors: Thomas E. Ryan, II, Santee, CA (US); Kyle J. Ryan, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/948,571

(22) Filed: Nov. 30, 2007

(51) Int. Cl. G05B 19/02

(52) U.S. Cl. 340/825.24; 340/5.61

(57) ABSTRACT

Customizing sounds for operating actions of an automobile, comprising: receiving signal emitted by a remote; determining a requested operating action corresponding to the signal; and assigning a customized sound to the requested operating action when a sound assignment is requested.

### BACKGROUND

1. Field of the Invention

The present invention relates generally to customizing sounds, and more particularly to customizing sounds for operating actions of automobiles.

2. Description of the Prior Art

Automobile owners take pride and joy in personalizing different aspects of their automobiles. Currently, although some aspects of an automobile can be customized, there is no mechanism that allows an owner to customize the emitted sounds when activating certain functions of an automobile.

### SUMMARY

Embodiments of the present invention include customizing sounds for operating actions of an automobile.

In one aspect, a method for customizing sounds for operating actions of an automobile is disclosed. The method include: receiving signal emitted by a remote; determining a requested operating action corresponding to the signal; and assigning a customized sound to the requested operating action when a sound assignment is requested.

In another aspect, a sound customization device is disclosed. The device includes: a receiver to receive signal emitted by a remote; a storage unit configured to store a plurality of customized sounds; a processor configured to: determine a requested operating action of an automobile corresponding to the received signal; select a customized sound from the plurality of customized sounds stored in the storage unit; and assign the selected sound to the requested operating action.

In yet another aspect, a computer-readable storage medium storing a computer program for customizing sounds for operating actions of an automobile is disclosed. The program comprises executable instructions that cause a computer to: receive a request for at least one of sound assignment and sound un-assignment; assign a customized sound to a requested operating action when a sound assignment request is received; and un-assign a customized sound from the requested operating action when a sound un-assignment request is received.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which:

FIG. 1 is a block diagram of a sound customization system in accordance with one implementation of the present invention;

FIG. 2 is a detailed block diagram of the sound customization device in accordance with one implementation of the present invention;

FIG. 3 shows a layout of a sound customization program used to manage assignment of sound data to a particular operating action of a vehicle;

FIG. 4 is a flowchart describing a process for customizing sound in accordance with one implementation of the present invention; and

FIG. 5 is a flowchart describing the assignment process in accordance with one implementation of the present invention.

### DETAILED DESCRIPTION

Certain implementations as disclosed herein provide for systems, methods, and programs to implement a technique of using sound customization for operating actions of automobiles. In particular implementations, sound customization is used for keyless entry to automobiles. Features provided in implementations include, but are not limited to, configuring and processing signal corresponding to a specific operating action of the vehicle, and assigning a sound to the specific operating action.

After reading this description it will become apparent to one skilled in the art how to practice the invention in various alternative implementations and alternative applications. However, although various implementations of the present invention will be described herein, it is understood that these embodiments are presented by way of example only, and not limitation. As such, this detailed description of various alternative implementations should not be construed to limit the scope or breadth of the present invention as set forth in the appended claims.

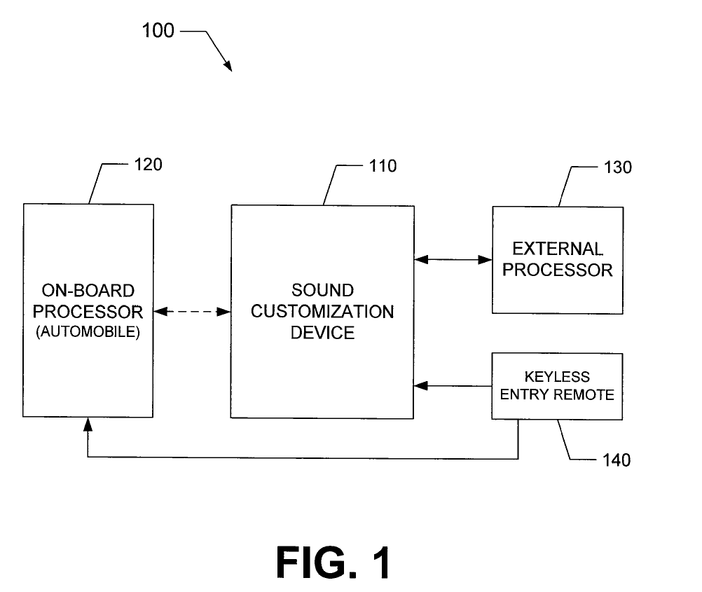

FIG. 1 is a block diagram of a sound customization system 100 in accordance with one implementation of the present invention. In the illustrated implementation, the sound customization system 100 includes: a sound customization device 110; an on-board processor 120; an external processor 130 such as, for example, a laptop computer; and a keyless entry remote 140 such as, for example, a key fob.

In one implementation, the sound customization device 110 is coupled to the on-board processor 120, which is arranged in an automobile to manage and monitor functions of the automobile. The sound customization device 110 is also coupled to the keyless entry remote 140 and an external processor 130. The sound customization device 110 operates, alone or in conjunction with the external processor 130 and/or the on-board processor 120, to process and control customized sounds corresponding to the operating actions that are controlled by the keyless entry remote 140.

In one example, a sound is an audio of a command “open” corresponding to an operating action of unlocking the door. The operating action includes locking or unlocking vehicle doors, trunk opening, opening of left or right sliding door, and other related actions. Thus, in one implementation, the sound customization device 110 assigns sounds to operating actions of the vehicle. In this implementation, the external processor 130 is used to change, add, remove, and/or rearrange correspondence between the sound and the operating action. When a signal is received from the keyless entry remote 140 corresponding to a specific operating action, such as unlocking the vehicle door, the sound customization device 110 plays the sound assigned to that specific operating action. Thus, in the above example, the sound customization device 110 plays the voice command “open” when the unlock button on the keyless entry remote 140 is pressed.

When a signal corresponding to a specific operating action is transmitted from the keyless entry remote 140, the signal is also received by the on-board processor 120, which processes the signal and performs the specific operating action. In the above example, the on-board processor 120 unlocks the vehicle door when the unlock button on the keyless entry remote 140 is pressed.

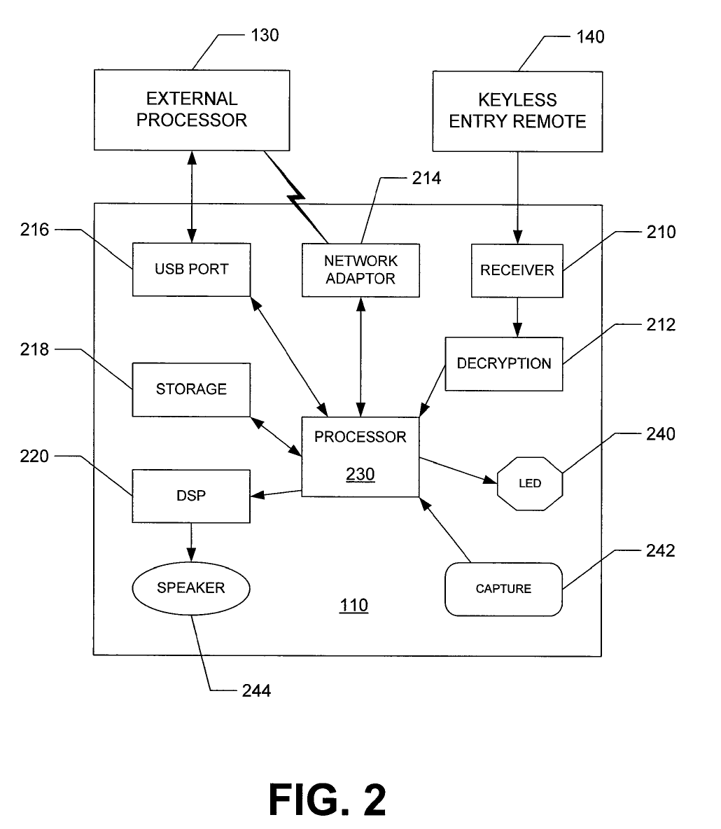

FIG. 2 is a detailed block diagram of the sound customization device 110 in accordance with one implementation of the present invention. In the illustrated implementation of FIG. 2, the sound customization device 110 includes a processor 230, a receiver 210, a decryption unit 212, a network adaptor 214, a USB port 216, a storage unit 218, a digital signal processor (DSP) 220, an LED 240, a capture button 242, and a speaker 244.

In the illustrated implementation, the receiver 210 of the sound customization device 110 is configured to receive signal emitted by a keyless entry remote 140. In one example, the keyless entry remote 140 includes a dealer-supplied key fob. The signal received by the receiver is typically a radio frequency (RF) signal. In one implementation, a unique frequency is assigned to each operating action. In another implementation, the keyless entry remote 140 uses a common frequency for all operating actions with each action being distinguished with a unique code modulated onto the common frequency. If the signal received at the receiver 210 is encrypted, the decryption unit 212 decrypts the encrypted signal, and sends the signal to the processor 230.

In one implementation, the processor 230 processes the received signal and determines which action corresponds to the signal when a capture command is in force (e.g., by pressing capture button 242). In another implementation, even if a capture command is not in force but the sound customization device 110 is in a mode set for capturing the frequency and/or code of the received signal, the processor 230 operates to determine which action corresponds to the received signal.

In one implementation, the processor 230 determines which action corresponds to the received signal by matching the frequency and/or code of the received signal to a user-specified action. In another implementation, the processor 230 determines which action corresponds to the received signal by matching the frequency and/or code of the received signal to a pre-defined action in a table stored in a storage unit 218.

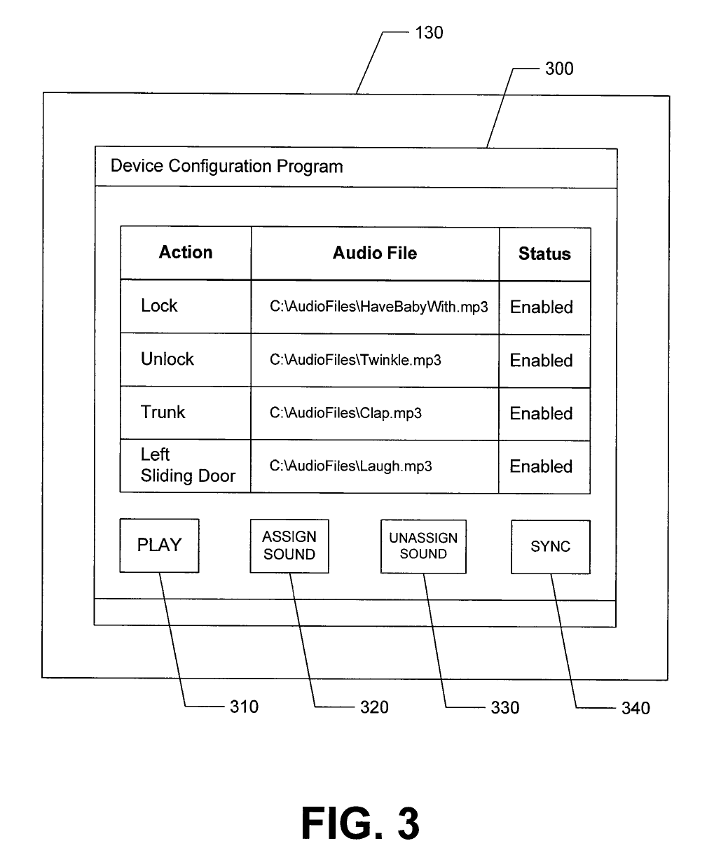

Once the frequency and/or code of the received signal have been matched to a user-specified action, the processor 230 operates to assign or un-assign a sound to the corresponding action, often under the direction of the external processor 130. Assignment and un-assignment processes are described below in detail in connection with the description of FIG. 3.

Once each operating action (e.g., of a vehicle) has been assigned to a particular sound(s), the sound customization device 110 retrieves and plays the sound assigned to the action corresponding to the received signal on each subsequent pressing of the action button on the keyless entry remote 140.

In one implementation, the sound customization device 110 is configured to receive pre-defined radio frequency or frequencies. Thus, in this implementation, the keyless entry remote 140 is configured to transmit pre-programmed signals (using at least one frequency and/or at least one code as described above) corresponding to specific operating action(s). That is, the keyless entry remote 140 is customized to emit signals of certain frequencies and/or codes that are different from the factory-defined frequencies and/or codes. Therefore, since the received signals in this implementation are not recognized by the on-board processor 120, the sound customization device 110 needs to be configured to inform the on-board processor 120 to perform the desired operating action based on the requested signal corresponding to the frequencies and/or codes of the received signal.

In illustrated implementation of FIG. 2, the external processor 130 (e.g., a user computer) uses the standard USB cable to connect to the USB port on the sound customization device 110. In other implementations, other communication interfaces such as, for example, a wireless interface is used to transfer sound data from the external processor 130 to the sound customization device 110. When a wireless interface is used, the sound customization device 110 is equipped with a wireless network adaptor that supports the latest Wifi security protocols. Thus, similar to other existing portable/wireless devices, configuration of the sound customization device 110 may be provided through a remote web browsers or direct USB connection.

Once the sound customization device 110 is recognized by the user computer, the user uploads/downloads audio, lyrics, phrases, and/or other related sounds (e.g., ring tones) to the sound customization device 110. The external processor 130 may use standard and/or customized software to manage the uploading and/or downloading process.

In another implementation, the sound customization system 100 manages the uploading and/or downloading process using a front panel display (not shown) connected to the on-board processor 120. In this implementation, standard and/or customized software for managing the uploading and/or downloading process is loaded onto the on-board processor. Thus, the user uploads/downloads audio, lyrics, and/or phrases to the sound customization device 110 using the front panel display of the vehicle.

In the illustrated implementation of FIG. 2, the processor 230 retrieves the sound data corresponding to the requested action from the storage 218. The processor 230 then sends the retrieved sound data to the DSP 220. The DSP processes the sound data and sends the processed data to the speaker 244. The processor may also use the LED 240 to indicate the status of its process.

In one implementation, the sound customization device 110 is transitioned into a signal capture mode by pressing the capture button 242 for a pre-specified amount of time. After holding the capture button 242 for the pre-specified amount of time, the sound customization device 110 makes a single beep signifying that it is ready to capture and record the signal. Upon signal-ready beep, the user presses and holds a particular action button on the keyless entry remote 140 while holding the capture button 242 down. The sound customization device 110 also uses the LED 240 to indicate that the device 110 is ready to capture and record the signal.

As described above, in one implementation, the processor 230 determines which action corresponds to the captured signal by matching the frequency and/or code of the signal to a user-specified action. In another implementation, the user specifies which action corresponds to the captured signal by pressing action indicator(s) (not shown) on the sound customization device 110 while the capture mode in force.

FIG. 3 shows a layout of sound customization program 300 used to manage assignment of sound data to a particular operating action of a vehicle. In one implementation, the program 300 is run on the external processor 130. In other implementations, the program 300 can be run on other processor such as the on-board processor 120.

In the illustrated implementation of FIG. 3, the program 300 retrieves the current state of the sound customization, which includes indication of correspondences between sound data and operating actions. This information is displayed on a display connected to the external processor. The program 300 can retrieve information indicating which actions are supported by the sound customization device 110. The program 300 also allows selection between “play” 310, “assign” 320, and “un-assign” 330 of sound data with respect to the operating actions. The program 300 can communicate with the sound customization device 110 to upload new sound data to the device 110 and specify which action to map the upload sound data using the sync button 340. In one implementation, the external processor 130 downloads the new sound data from a customized sound distribution outlet, such as a website.

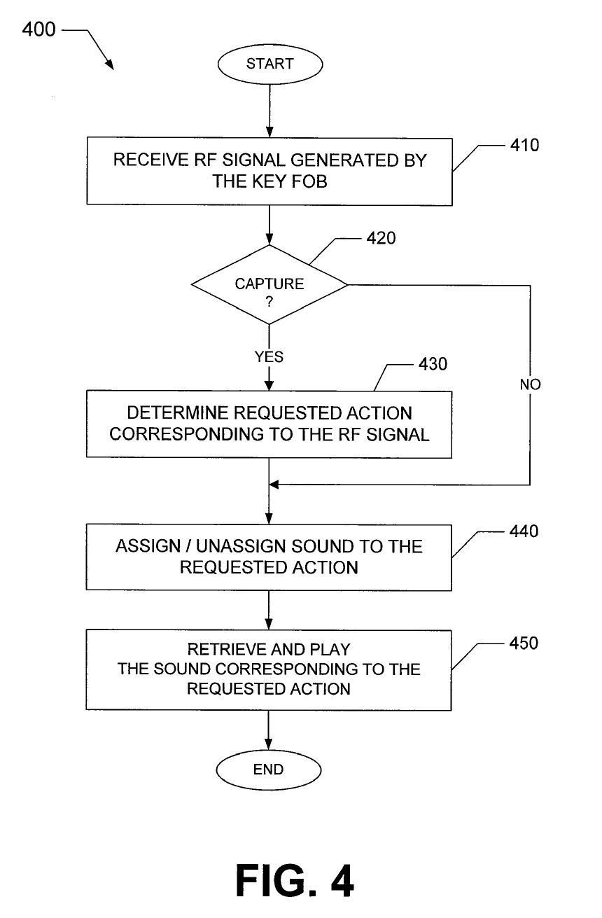

FIG. 4 is a flowchart describing a process 400 for customizing sound in accordance with one implementation of the present invention. In the illustrated implementation of FIG. 4, a signal emitted by a keyless entry remote 140 is received, at 410. As described above, the received signal is typically a radio frequency (RF) signal. In one implementation, a unique frequency is assigned to each operating action. In another implementation, the keyless entry remote 140 uses a common frequency for all operating actions with each action being distinguished with a unique code modulated onto the common frequency.

If it is determined, at 420, that a capture command is in force, the received signal is processed to determine, at 430, which action corresponds to the received signal. In one implementation, the determination is made by matching the frequency and/or code of the received signal to a user-specified action. In another implementation, the determination is made by matching the frequency and/or code of the received signal to a pre-defined frequency and/or code stored in the sound customization device 110.

Once the frequency and/or code of the received signal have been matched to a user-specified action under the capture command, a sound is assigned or unassigned to/from the requested action, at 440. The sound assignment/un-assignment process performs at least one of: assigning a customized sound to the requested operating action when a sound assignment is requested; and un-assigning a customized sound from the requested operating action when a sound un-assignment is requested.

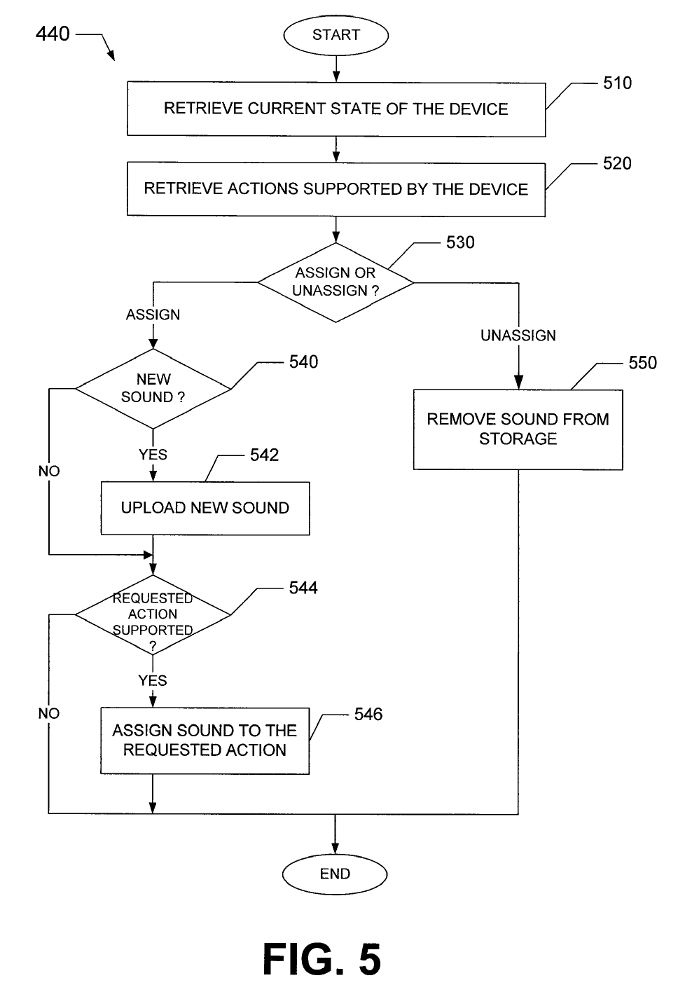

Details of the sound assignment/un-assignment process are described below in describing FIG. 5. In some implementations, the sound assignment can be made to the received signal rather than to the requested action.

Once each operating action (e.g., of a vehicle) has been assigned to a particular sound(s), the sound customization device 110 retrieves and plays, at 450, the sound assigned to the action corresponding to the received signal on each subsequent pressing of the action button on the keyless entry remote 140.

FIG. 5 is a flowchart describing the assignment/un-assignment process 440 in accordance with one implementation of the present invention. In the illustrated implementation of FIG. 5, a current state of the sound customization device 110 is retrieved, at 510. In one implementation, the current state includes indication of correspondences between sound data and operating actions. Information indicating which actions are supported by the sound customization device 110 is retrieved, at 520.

If the user requests assignment of a sound to an operating action, at 530, a determination is then made, at 540, whether the sound requested in the assignment is a new sound. If the requested sound is a new sound, then the new sound is uploaded, at 542. The requested sound is determined to be a new sound if the sound is not already available in the sound customization device 110 or if the sound is readily available. Further, if it is determined (at 544) that the requested action is an action supported by the sound customization device 110, the sound is assigned to the requested action, at 546. Otherwise, if the user requests un-assignment of a sound from an operating action (at 530), the sound is removed from a storage unit, at 550.

It will be appreciated that the various illustrative logical blocks, modules, and methods described in connection with the above-described figures and the implementations disclosed herein have been described above generally in terms of their functionality. In addition, the grouping of functions within a module is for ease of description. Specific functions or steps can be moved from one module to another without departing from the invention. Moreover, it should be noted that the steps need not be executed in the order in which they are presented in the flow diagrams. It should also be noted that the steps and/or processes for the flowcharts described above can be implemented as a computer program stored on a computer-readable storage medium.

The above descriptions of the disclosed implementations are provided to enable any person skilled in the art to make or use the invention. Various modifications to these implementations will be readily apparent to those skilled in the art, and the generic principles described herein can be applied to other implementations without departing from the spirit or scope of the invention. Thus, it will be understood that the description and drawings presented herein represent implementations of the invention and are therefore representative of the subject matter which is broadly contemplated by the present invention. It will be further understood that the scope of the present invention fully encompasses other implementations that may become obvious to those skilled in the art and that the scope of the present invention is accordingly limited by nothing other than the appended claims.

What is claimed is:

1. A method of customizing sounds for operating actions of an automobile, the method comprising:
receiving signal emitted by a remote;
determining a requested operating action corresponding to the signal; and
assigning a customized sound to the requested operating action when a sound assignment is requested.

2. The method of claim 1, further comprising
retrieving and playing the customized sound assigned to the requested operating action when a signal corresponding to the requested operating action is received from the remote.

3. The method of claim 1, wherein
the remote includes a keyless entry remote of the automobile.

4. The method of claim 1, wherein the signal emitted by the remote is received at a sound customization device, and wherein said assigning a customized sound comprises
uploading the sound to the customization device when the sound to be assigned is not already available on the customization device.

5. The method of claim 1, further comprising
un-assigning the customized sound from the requested operating action when a sound un-assignment is requested.

6. The method of claim 1, wherein the signal emitted by the remote is received at a sound customization device, and wherein said un-assigning a customized sound comprises
removing the sound from a storage unit of the sound customization device.

7. The method of claim 1, wherein the customized sound comprises
at least one of audio, lyrics, phrases, and other related sounds.

8. The method of claim 1, wherein the signal emitted by the remote comprises
a radio frequency signal of a particular frequency.

9. The method of claim 1, wherein said determining a requested operating action corresponding to the signal comprises
matching frequency and/or code of the signal to the requested operating action.

10. A sound customization device, comprising:
a receiver to receive signal emitted by a remote;
a storage unit configured to store a plurality of customized sounds;
a processor configured to:
determine a requested operating action of an automobile corresponding to the received signal;
select a customized sound from the plurality of customized sounds stored in the storage unit; and
assign the selected sound to the requested operating action.

11. The sound customization device of claim 10, further comprising:
a speaker; and
a digital signal processor configured to retrieve the selected sound assigned to the requested operating action and play the selected sound on said speaker.

12. The sound customization device of claim 10, further comprising
a capture button configured to notify said processor to be prepared to determine the correspondence between the received signal and a requested operating action of the automobile.

13. The sound customization device of claim 10, wherein
the remote includes a key fob of the automobile.

14. The sound customization device of claim 10, wherein the customized sound comprises
at least one of audio, lyrics, phrases, and other related sounds.

15. A computer-readable storage medium storing a computer program for customizing sounds for operating actions of an automobile, the program comprising executable instructions that cause a computer to:
receive a request for at least one of sound assignment and sound un-assignment;
assign a customized sound to a requested operating action when a sound assignment request is received; and
un-assign a customized sound from the requested operating action when a sound un-assignment request is received.

16. The computer program of claim 15, further comprising executable instructions that cause a computer to
upload the sound when the sound to be assigned is not readily available.

17. The computer program of claim 15, wherein the customized sound comprises
at least one of audio, lyrics, phrases, and other related sounds.

18. The computer program of claim 15, further comprising executable instructions that cause a computer to
download the sounds from a customized sound distribution outlet.
